(19) United States
(12) Patent Application Publication
(10) Pub. No.: US 2026/0239435 A1
(43) Pub. Date: Aug. 13, 2026

(54) RANDOM ACCESS PROCEDURES FOR LOW-POWER DEVICES

(71) Applicant: QUALCOMM Incorporated, San Diego, CA (US)

(72) Inventors: Luanxia YANG, Beijing (CN); Piyush GUPTA, Bridgewater, NJ (US); Xiaojie WANG, Hillsborough, NJ (US); Junyi LI, Greentown, PA (US)

(21) Appl. No.: 19/153,508

(22) PCT Filed: Mar. 15, 2023
(86) PCT No.: PCT/CN2023/081541

§ 371 Date: Aug. 4, 2025

(51) Int. Cl. H04W 74/0833; H04L 5/00

(52) U.S. Cl. CPC H04W 74/0833; H04L 5/0012; H04L 5/0055

(57) ABSTRACT

Random access procedures for low-power devices are described herein. In one example, a method for random access includes receiving, from a network entity during a random access response monitoring window, a random access response, including: an identifier associated with the network entity; and an uplink resource allocation; and sending, to the network entity, an uplink message scrambled with the identifier, the uplink message comprising: an identifier associated with the user equipment; and a setup request.

### BACKGROUND

### Field of the Disclosure

Aspects of the present disclosure relate to wireless communications, and more particularly, to random access procedures for low-power devices, such as internet of things (IoT) devices.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for performing initial access by a user equipment. The method includes receiving, from a network entity during a random access response monitoring window, a random access response (RAR), comprising: an identifier associated with the network entity; and an uplink resource allocation; and sending, to the network entity, an uplink message scrambled with the identifier, the uplink message comprising: an identifier associated with the user equipment; and a setup request.

Another aspect provides a method for performing initial access by a network entity. The method includes sending, to a user equipment during a random access response monitoring window, a RAR, comprising: an identifier associated with the network entity; and an uplink resource allocation; and receiving, from the user equipment, an uplink message scrambled with the identifier, the uplink message comprising: an identifier associated with the user equipment; and a setup request.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts example components of an energy harvesting-capable UE.

FIG. 6 depicts aspects relating to different RF energy harvesting and RF communication architectures for an energy harvesting-capable device.

FIG. 7A is an example message flow diagram illustrating an example four-step RACH procedure performed between a UE and a network entity,

FIG. 7B is an example message flow diagram illustrating an example two-step RACH procedure performed between a UE and a network entity.

FIGS. 8A and 8B depict random access response monitoring window concepts.

FIGS. 9A and 9B depict contention resolution concepts for random access.

FIG. 10 depicts another contention resolution concept.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for performing random access procedures for low-power devices, including so-called “ambient IoT” devices.

Wireless communication systems generally implement a random-access channel (RACH) and RACH procedures that are used by user equipments (UEs) to access a network provided by the system for data communication. For example, a RACH procedure and channel may be used for initially accessing and for reestablishing access to the network when a UE switches between radio resource control (RRC) modes, such as idle, connected (active), and connected (inactive) modes, as well as when handing over between network entities in RRC connected modes. Aspects of the present disclosure provide RACH procedures and techniques for UEs, including low-power UEs like ambient IoT devices.

In wireless communication systems, functional capabilities are often defined according to device type. For example, higher-end user equipments (UEs) may generally have more antennas, wider bandwidths, and higher peak data rates, while lower-end UEs may generally have fewer antennas, narrower bandwidths, and lower peak data rates. “Typing” UEs allows for defining common sets of functional capabilities for all UEs of a particular type and generally improves interoperability between UEs and network entities within a wireless communication system. In some cases, as described herein, the type of a UE will affect its network access (e.g., RACH) procedure.

Various device types may be referenced within wireless communication system standards, such as 3GPP. For example, enhanced mobile broadband eMBB, reduced capability (RedCap), massive machine type communications (mMTC), narrowband IoT, passive IOT, ultra-reliable low latency communications (URLLC) are all types of user equipment associated with various functional capabilities. Various aspects are described herein with reference to ambient IoT devices (e.g., UEs), such as active IoT devices, semi-passive IoT devices, and passive IoT devices.

Generally, ambient IoT devices may include several device subclasses. including active IoT devices, semi-passive IoT devices, and passive-IoT devices. Ambient IoT devices are generally capable of operating based on energy harvested from the ambient environment, such as from received radio frequency (RF) energy, solar energy, vibrational energy, and others.

An active IoT device is generally capable of harvesting ambient energy as well as using energy stored onboard the device, such as in a battery or capacitor. An active IoT device generally includes both active radio equipment (e.g., an active radio) and passive radio equipment (e.g., a backscatter-type radio). A backscatter-type radio uses existing radio frequency signals to transmit data by modifying and reflecting received signals with encoded data. Capabilities of an active IoT device may thus be similar as those of an NR-type of UE with the addition of energy harvesting capabilities.

A semi-active IoT device is generally capable of harvesting ambient energy as well as using energy stored onboard the device, and likewise generally includes both active radio equipment and passive radio equipment, like a backscatter-type radio. In some cases, semi-active IoT devices may be capable of synchronous (e.g., course synchronous) and asynchronous communication. In some cases, semi-active IoT devices may omit a power amplifier and/or a low-noise amplifier. Further, semi-active IoT devices may generally utilize a light protocol stack (e.g., compared to an active IoT device). These aspects of semi-active IoT device generally help to balance power needs, functionality, and cost. So-called “ultra-light IoT” devices are one type of semi-active IoT device.

A passive IoT device is generally capable of operating based on energy harvested from the environment using passive radio equipment (e.g., a backscatter-type radio). Passive IoT UEs are generally capable of asynchronous communication and may not have a power amplifier or a low-noise amplifier. Passive IoT UEs may generally utilize a light protocol stack.

A technical problem for low-power UEs, such as ambient IoT UEs, is energy management, and in particular minimizing energy consumption for various wireless communication system functions, including random access. Conventional RACH procedures do not account for the energy sensitivity of ambient IoT UEs and thus may cause an outsized energy impact on such UEs when establishing (or reestablishing) access to a wireless communication system.

Aspects described herein overcome the aforementioned technical problem by providing power-efficient random access procedures for ambient IoT UEs. In particular, aspects described herein provide both four-step and two-step random access procedures that improve the efficiency of random access procedures. In particular, the technical effect of the four-step and two-step random access procedures described herein is to reduce latency and power consumption during the random access procedure performed by low-power devices, such as ambient IoT devices.

In some aspects described herein, a UE, such as an ambient IoT UE, is configured to perform a random access method, including receiving, from a network entity during a random access response monitoring window, a random access response, comprising: an identifier associated with the network entity; and an uplink resource allocation; and sending, to the network entity, an uplink message scrambled with the identifier, the uplink message comprising; an identifier associated with the user equipment; and a setup request.

In some aspects described herein, a network entity is configured to perform a random access method, including: sending, to a user equipment during a random access response monitoring window, a random access response, comprising: an identifier associated with the network entity; and an uplink resource allocation; and receiving, from the user equipment, an uplink message scrambled with the identifier, the uplink message comprising: an identifier associated with the user equipment; and a setup request.

In the aforementioned methods, the random access response supports both four-step and two-step random access procedures and reduces latency, energy consumption, and collisions between devices compared to conventional methods. The technical effect of these aspects is to reduce the latency of random access procedures, which beneficially reduces power consumption by the UE and leads to efficient use of the network entities' time-frequency resources.

further technical problem related to random access procedures is determining when a low-power device, such as an ambient IoT device, can receive a random access response from a network entity. Aspects described herein overcome this technical problem by providing a configuration for the random access response monitoring window. In some aspects, the configuration for the random access response monitoring window may be received by a UE via one of a system information message or a radio resource control message and may include: (1) a starting time based on a time interval after a most recent physical random access channel reception or an absolute starting time if there is time synchronization between the UE and the network entity; and (2) a duration of the random access response monitoring window. The technical effect of these aspects is to improve reception of the random access request and therefore reduce latency of random access, which beneficially reduces power consumption by the UE and leads to efficient use of the network entities' time-frequency resources.

A further technical problem related to random access procedures is how to resolve contention amongst UEs trying to access the same network. Aspects described herein overcome this technical problem by providing a random access response including an indication of a candidate set of frequency resources for the UE to transmit an uplink message. In some aspects, the indication of the candidate set of frequency resources for the uplink message is based on a maximum division factor for a frequency hopping step size for the UE. In some aspects, the UE is configured to select the frequency resource from the candidate set of frequency resources for the uplink message based at least in part on a device identifier for the UE. The technical effect of these aspects is to reduce contention time and therefore reduce latency of random access, which beneficially reduces power consumption by the UE and leads to efficient use of the network entities' time-frequency resources.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

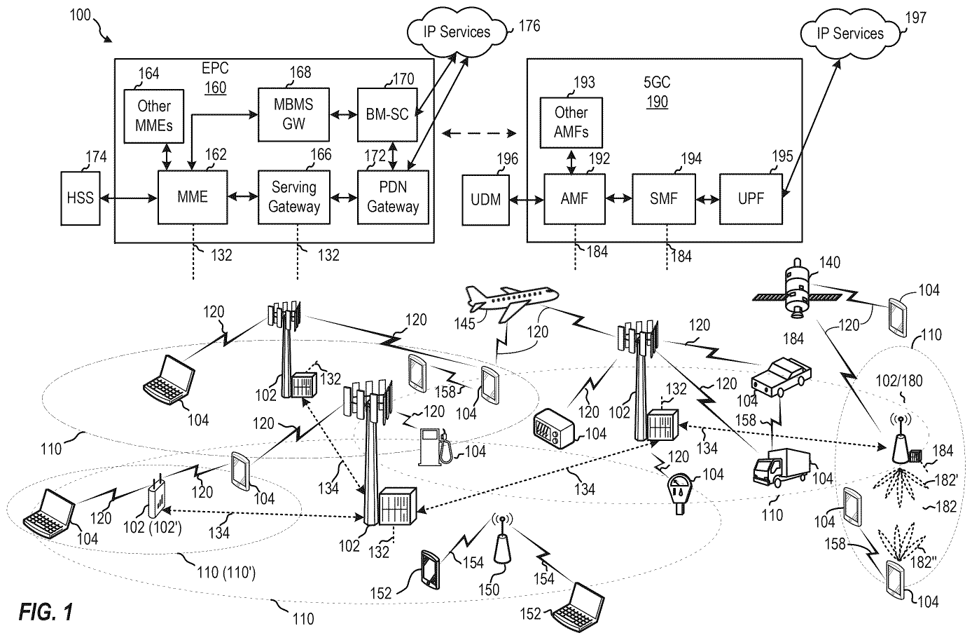

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

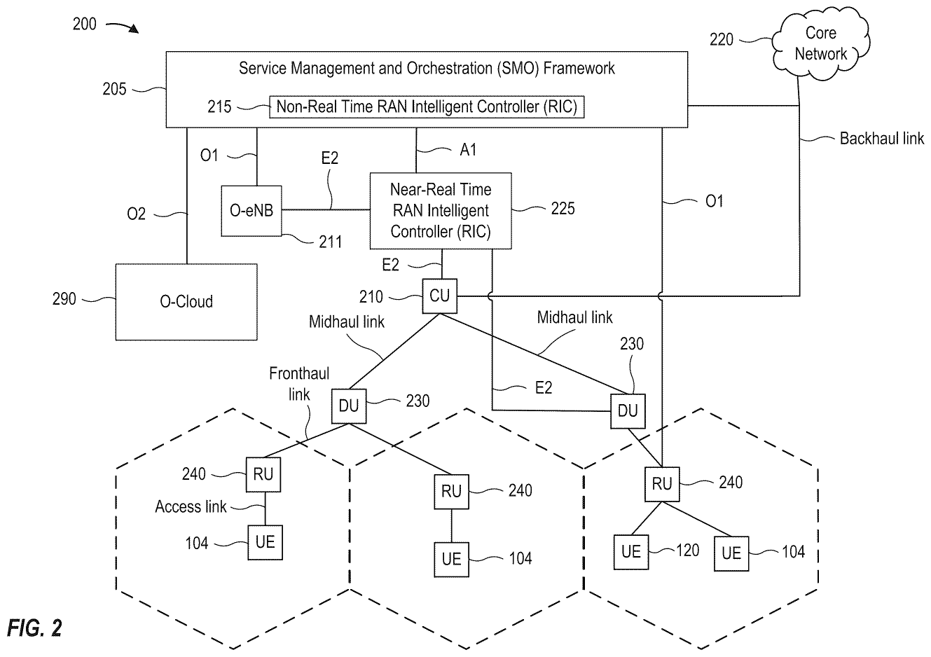

While BSs 102 are depicted in various aspects as unitary communications devices, BSs 102 may be implemented in various configurations. For example, one or more components of a base station may be disaggregated, including a central unit (CU). one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR 2) as including 24,250 MHz-52,600 MHz, which is sometimes referred to (interchangeably) as a “millimeter wave” (“mmW” or “mm Wave”). A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery, BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) arca broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

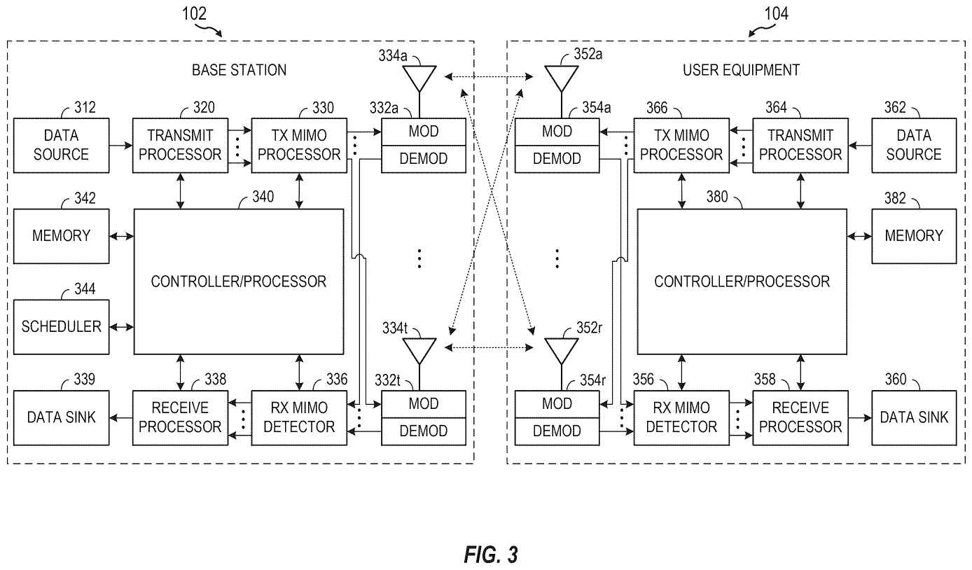

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352 a-r (collectively 352), transceivers 354 a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

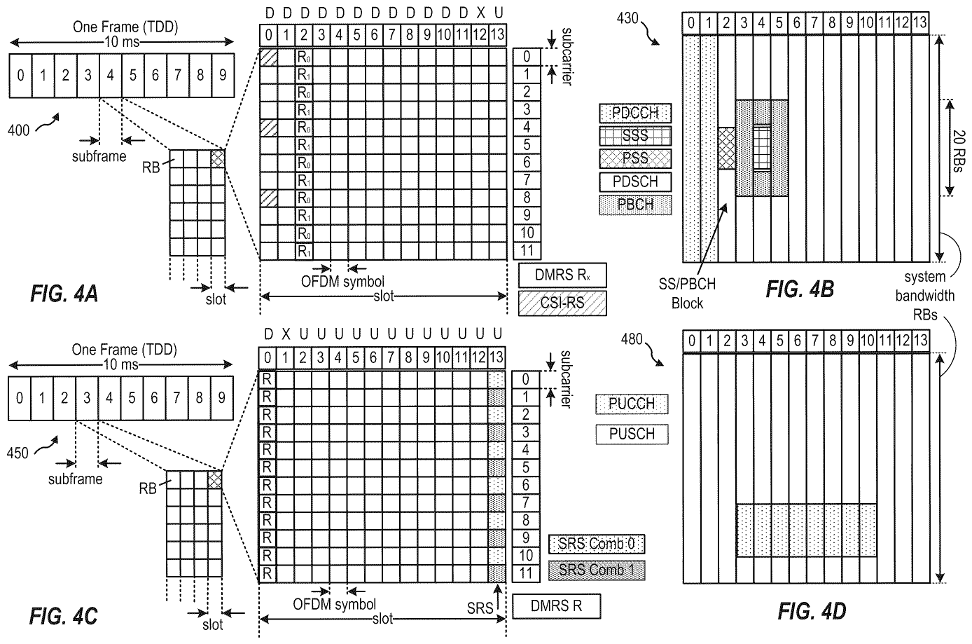

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 24^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by cach RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Aspects of a Low-Power UE With Energy Harvesting

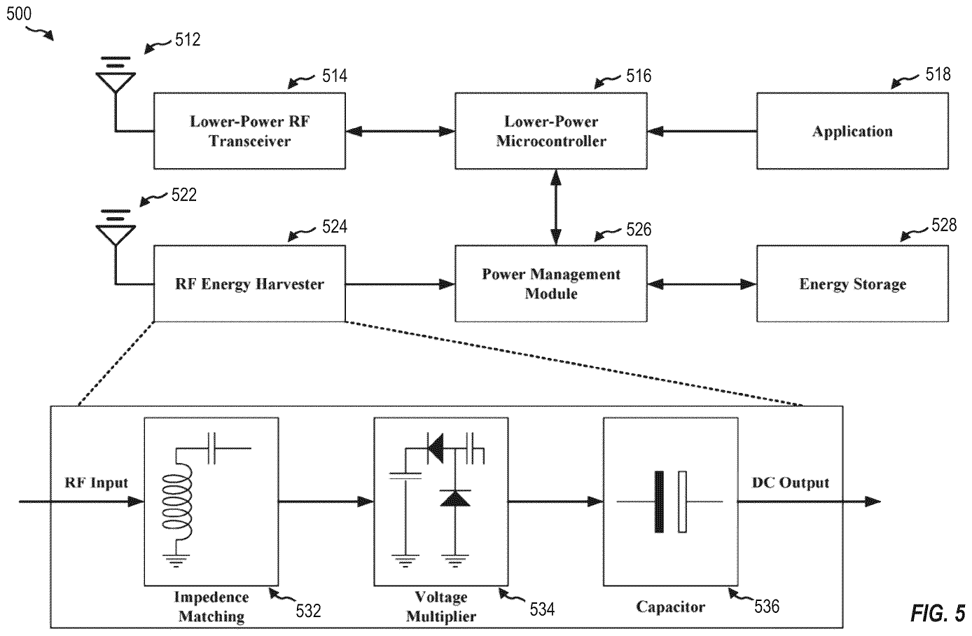

FIG. 5 depicts example components 500 of an energy harvesting-capable UE. Various example components 500 may be incorporated into ambient IoT devices.

In this example, components 512-518 are aspects of a data transmission pipeline. In particular, antenna 512 and RF transceiver 514 (e.g., a low power RF transceiver) may transmit and/or receive data. Microcontroller 516 (e.g., a low power microcontroller) may process data received from an application 518.

Further in this example, components 522-528 are aspects of an RF-energy-harvesting pipeline. In particular, antenna 522 and an RF energy harvester 524 are configured to harvest RF energy. In some aspects, RF energy harvester 524 includes an impedance matching circuit 532, a voltage multiplier 534, and a capacitor 536 to collect RF signals and convert them into electricity. In some aspects, a power management module 526 is configured to decide whether to store the electricity obtained from the RF energy harvester 524 or to use it for information transmission immediately. In this example, energy storage 528 (e.g., a battery) is configured to store energy converted by the RF energy harvester 524.

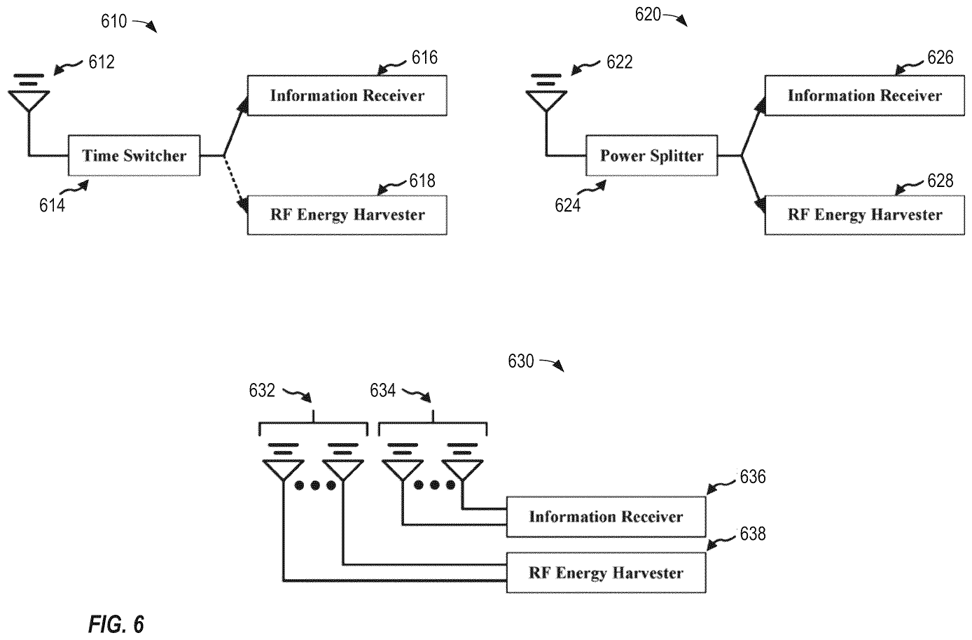

As above, in various aspects, an ambient IoT UE may include the components depicted and described with respect to FIG. 5. In some aspects, a passive IoT UE may omit certain aspects depicted and described with respect to FIG. 5, such as energy storage 528. Further, while multiple antennas (512 and 522) are depicted in this example, in others, a single antenna and antenna switching component may be used to share the antenna between transceiver 514 and RF energy harvester 524, such as described further with respect to FIG. 6.

FIG. 6 depicts aspects 610, 620, and 630 relating to different RF energy harvesting and RF communication architectures for an energy harvesting-capable device, such as an ambient IoT UE.

In particular, aspect 610 depicts antenna 612 connected to time switcher 614. In some aspects, time switcher 614 is configured to allow an energy harvesting-capable UE to switch between (1) being connected to information receiver 616 and (2) being connected to RF energy harvester 618. For example, the device may exchange wireless communication and RF energy at different, e.g., non-overlapping, times.

Aspect 620 depicts antenna 622 connected to power splitter 624. In some aspects, power splitter 624 is configured to allow an energy harvesting-capable device to distribute power between (1) information receiver 626 and (2) RF energy harvester 628. Thus, in this example, the device may exchange wireless communication and RF energy at overlapping times. For example, a received RF signal may be split into two streams, with one stream for the information receiver 626 and the other stream for the RF energy harvester 628.

Aspect 630 depicts an example separated receiver architecture. In particular, a first set of antennas 632 is connected with an RF energy harvester 638 and a second set of antennas 634 is connected with information receiver 636. FIG. 5, described above, depicts a separated receiver architecture.

RF energy may be harvested from various signal types. For example, RF energy may be harvested via one or more of a deterministic signal (e.g., a pilot signal), a random signal such as a circularly symmetric complex Gaussian random signal, and/or an improper complex Gaussian random signal (e.g., a signal in which real and imaginary components have different variances).

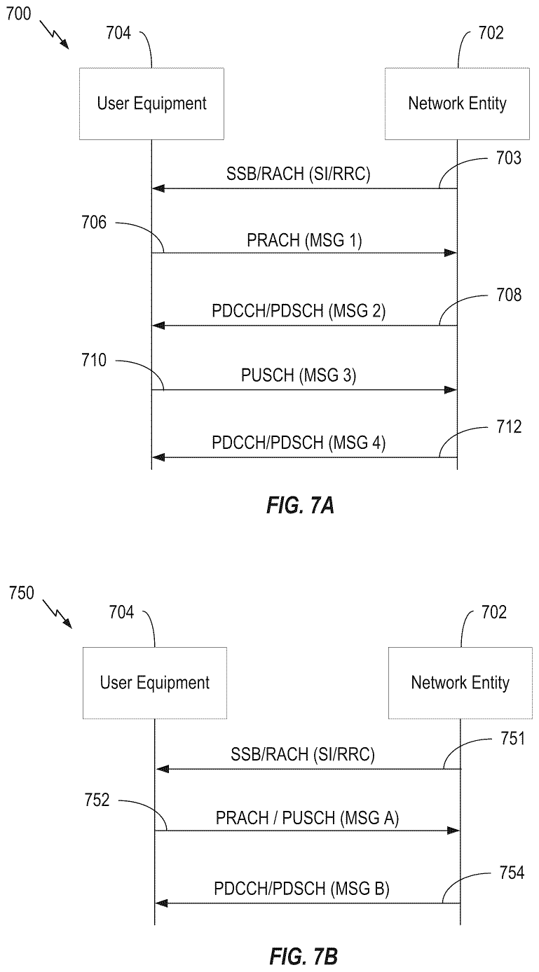

General Introduction to Four-Step and Two-Step Random Access Procedures FIG. 7A is an example message flow diagram 700 illustrating an example four-step RACH procedure performed between UE 704 and network entity 702. In some aspects, UE 704 is an example of a UE such as 102 and network entity 702 is an example of a base station 104 as described above with respect to FIGS. 1 and 3.

Initially, at 703, network entity 702 broadcasts and UE 704 receives a random access configuration over a RACH, for example in system information within a synchronization signal block, or within an RRC message.

At 706, UE 704 sends a first message (MSG 1) to network entity 702 on a physical random access channel (PRACH). In some aspects, MSG 1 may include a RACH preamble.

At 708, network entity 702 responds with a random access response (RAR) message (MSG 2), which may include, for example, an identifier (ID) of the RACH preamble, a timing advance, an uplink grant (e.g., resource), cell radio network temporary identifier (C-RNTI), and a back off indicator. Further, MSG 2 may include a PDCCH communication including control information for a following communication on the PDSCH.

At 710, in response to MSG 2, UE 704 transmits MSG 3 to network entity 702 on the PUSCH. In some aspects, MSG 3 may include an RRC connection request, a tracking area update, and a scheduling request. Generally, MSG 3 uses an uplink resource indicated in the RAR.

Finally, at 712, network entity 702 responds to MSG 3 with MSG 4, which may include a contention resolution message.

In some cases, to speed random access, a two-step RACH procedure may be employed. As the name implies, the two-step RACH procedure may effectively consolidate the four messages of the four-step RACH procedure into two messages.

FIG. 7B is an example message flow diagram 750 illustrating an example two-step RACH procedure performed between UE 704 and network entity 702. In some aspects, UE 704 is an example of a UE such as 102 and network entity 702 is an example of a base station 104 as described above with respect to FIGS. 1 and 3.

Initially, at 751, network entity 702 broadcasts and UE 704 receives a random access configuration over a RACH, for example in system information within a synchronization signal block, or within an RRC message.

At 752, UE 704 sends a first message (MSG A) to network entity 702, which may effectively combine MSG 1 and MSG 3 described above with respect to FIG. 7A. In some aspects, MSG A includes a RACH preamble for random access and a payload. For example, the payload may include a UE-ID and other signaling information, such as a buffer status report or scheduling request.

In some aspects, a PUSCH configuration includes a mapping between one or multiple PRACH preambles and a PUSCH occasion associated with a DMRS resource. In such cases, a UE may determine time resources and frequency resources for PUSCH occasions (such as used for MSG A) in an active uplink bandwidth part from, for example, a “msgA-PUSCH-Config” for the active uplink bandwidth part. If the active uplink bandwidth part is not the initial uplink bandwidth part and “msgA-PUSCH-Config” is not provided for in the active uplink bandwidth part, the UE may use the “msgA-PUSCH-Config” provided for the initial uplink bandwidth part instead.

At 754, network entity 702 responds with a random access response message (MSG B), which may effectively combine MSG 2 and MSG 4 described above. For example, MSG B may include the ID of the RACH preamble, a timing advance, a back off indicator, a contention resolution messages, an uplink and/or downlink grant, and transmit power control commands.

Aspects Related To Content of a Random Access Response Message for Random Access Procedures for Low-Power UEs

As described briefly above with respect to FIGS. 7A and 7B, RACH procedures involve the sending and receiving of messages between UEs and network entities to establish a connection. Each such transmission and reception involves energy consumption by the network and the UE seeking a connection. For any UE, and especially low-power UEs, reducing the amount of data exchanged during a RACH procedure is beneficial in that it reduces power consumption by the UE. In aspects described herein, a RAR message may be configured to reduce the amount of data necessary for the RACH procedure, thereby reducing power consumption at the UE and improving network efficiency.

As described briefly above with respect to FIGS. 7A and 7B, MSG 2 in a four-step RACH procedure and MSG B in a two-step RACH procedure may include a RAR message from a network entity.

In a four-step RACH procedure, a network entity may send a RAR message to a low-power UE, such as an ambient IoT UE, including various information.

In some aspects, the four-step RAR message includes a temporary cell radio network temporary identifier (TC-RNTI), which may be generated by a network entity (and thus be associated with the network entity), and which may be used by the UE during a contention based random access procedure. For example, the UE may store the TC-RNTI (received in RAR) and use it for scrambling of MSG 3. During a contention-based random access procedure, the UE monitors the PDCCH scrambled with TC-RNTI and may promote the TC-RNTI to a C-RNTI upon random access success.

In some aspects, the four-step RAR message may further include a preamble indication. In order make the RAR message more compact, the preamble indication may be an index associated with the received preamble, rather than the preamble itself. The index can be, for example, a number, or character, or sequence of numbers and/or characters, or other indicia, which uniquely identifies the preamble. In some cases, a table (or similar) may be predefined that associates different indexes with different preambles. The table may be preconfigured on the UE and network entity or transmitted to the UE by the network entity, for example, in RACH configuration information (such as in message 703 and 751 described above with respect to FIGS. 7A and 7B, respectively). The data saved by sending only an index associated with the received preamble rather than the entire preamble itself may be particularly beneficial to low-power UEs, such as ambient IoT UEs, that have limited or no onboard energy storage device because less energy needs to be used to decode the index as compared to the entire preamble.

As another alternative, in some aspects, a function may be defined that takes a starting timing, frequency, and/or step size of a frequency hopping pattern used by the UE as inputs to generate a preamble indication. Here again, the preamble indication generated by the function may be more compact and thus more efficient to transmit by the network entity and to decode by the UE as compared to transmitting and decoding the entire preamble.

As another alternative, in some aspects, a table (or similar) may be predefined that maps between a preamble and the PRACH upon which the preamble is sent by the UE.

In some aspects, the four-step RAR message further includes a resource allocation for an uplink transmission, as described above.

In some aspects, the four-step RAR message further includes a random value secd. As described in more detail below, the random value seed may be used for contention resolution.

### Aspects Related To Monitoring for a Random Access Response Message for Random Access Procedures for Low-Power UEs

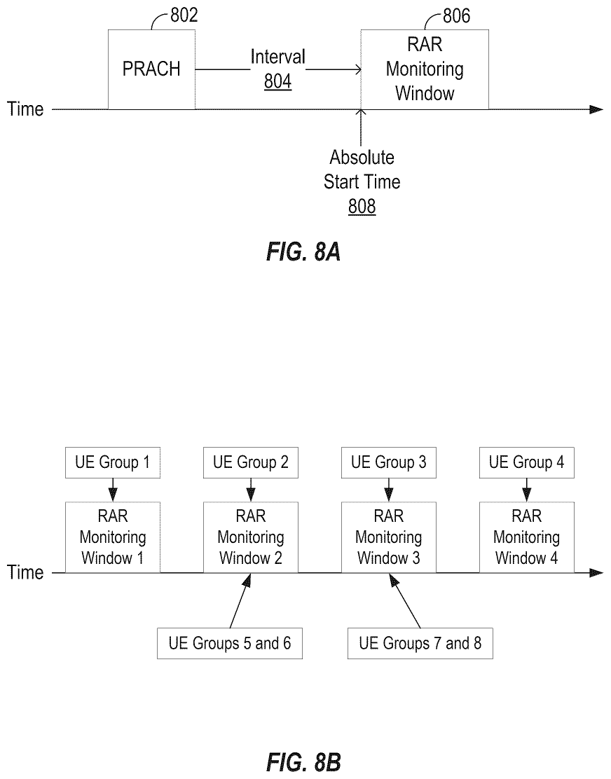

RACH procedures are inherently based on randomly timed access requests from UEs and collisions between different UEs making requests are possible. To reduce the chances of collisions, and thus beneficially reduce latency in the RACH procedure, RAR monitoring windows may be configured. In general, a network entity may configure time-division multiplexed (TDM) resources (e.g., different time-based monitoring windows) for RAR monitoring as well as FDM resources (different frequencies) for RAR monitoring. FIGS. 8A and 8B depict various monitoring window options.

In particular, FIG. 8A depicts two separate RAR monitoring window concepts. First, the RAR monitoring window 806 may be defined based on a relative start time, such as based on an interval 804 starting at the beginning (or end) of PRACH transmission 802 (e.g., MSG 1 of a four-step RACH procedure or MSG A of a two-step RACH procedure). For example, RAR monitor window 806 can be defined as starting a number of frames, slots, or mini-slots after the start or end of PRACH transmission 802. Further, RAR monitor window 806 can be defined as having a duration based on, for example, an RRC parameter, such as “ra-Response Window”, which indicates the duration of the monitoring window.

Second, RAR monitoring window 806 may be defined based on an absolute start time 808, such as a specific frame, slot, or mini-slot. Note that for an absolute start time, a UE would need to be synchronized in time with the network entity with which it is performing the RACH procedure.

FIG. 8B depicts two further RAR monitoring window concepts. First, groups of UEs can each be associated with a specific time monitoring window. In the depicted example, UE group 1 can be associated with RAR monitoring window 1, UE group 2 can be associated with RAR monitoring window 2, UE group 3 can be associated with RAR monitoring window 3, and UE group 4 can be associated with RAR monitoring window 4.

Alternatively, multiple groups of UEs may be associated with a single RAR monitoring window. For example, as depicted, UE groups 5 and 6 are mapped to RAR monitoring window 2 and UE groups 7 and 8 are mapped to RAR monitoring window 3. In some cases, all UE groups (e.g., being served by a particular network entity) may be mapped to a specific RAR monitoring window.

In various aspects, the concepts of FIGS. 8A and 8B may be predefined or configured by system information (e.g., in a SIB) or in RRC messaging to a UE.

By defining specific monitoring windows, a low-power UE may be able to forgo monitoring in other time periods and thereby beneficially reduce energy consumption.

### Aspects Related To Contention Resolution During Random Access Procedures for Low-Power UEs

As discussed briefly above, it is possible that multiple UEs will transmit the same preamble at the same time (e.g., based on the same start frequency and frequency hopping pattern) and thereafter may transmit MSG 3 at the same time during a RACH procedure. This may create a collision between one or more UEs, which then requires one or more UEs to restart the RACH procedure. Restarting the RACH procedure causes additional energy consumption by the UE and the network, and wastes time-frequency resources.

As above, a RAR message may include a random value seed that can be used for determining a time window in which to transmit a MSG 3 during the RACH procedure. By randomly seeding different UEs with different time windows, collisions are beneficially reduced.

In some aspects, the random value seed included in a RAR message may be a value X, and a UE will randomly choose a counter value from [0, 2^{X}−1]. Only a UE with a counter value of 0 will transmit MSG 3, and after a fixed time interval, all UEs will decrement their counter by some fixed number (e.g., by 1). Note that in such cases, a maximum counter value may be defined and a UE randomly choosing a counter value higher than the maximum counter value may terminate its RACH procedure and start over. Otherwise, a network may transmit a RACH procedure termination or time out message after a fixed interval of time after transmitting the RAR message with no response from the UE.

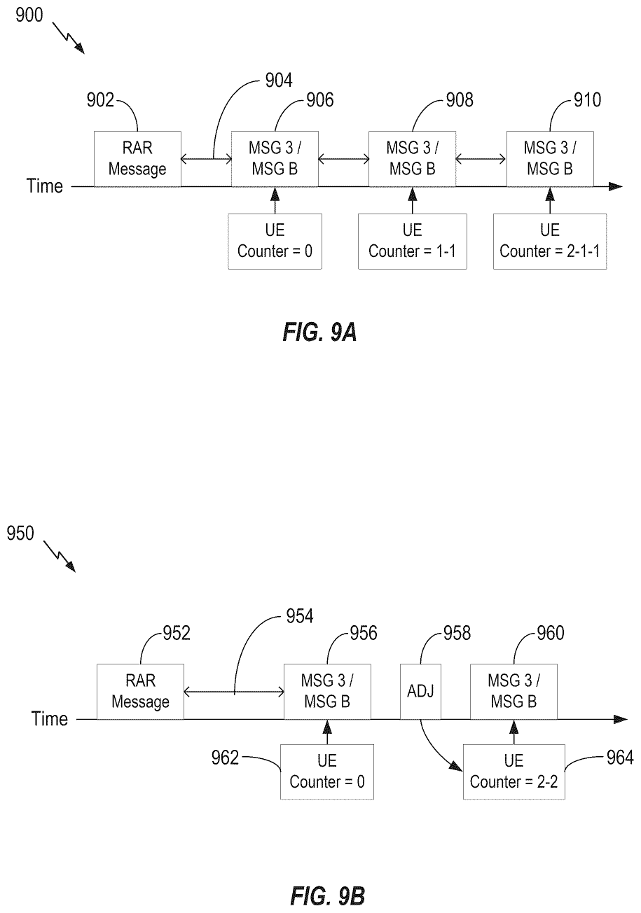

FIG. 9A depicts an example 900 in which a RAR message 902 is sent and after a number of fixed intervals 904, a UE will transmit a MSG 3 in response to the RAR message 902. For example, a UE with a counter value of 0 at 906 would transmit its MSG 3 at 906. As another example, a UE with a counter value of 1 at 906 would wait another interval 904 and have a counter value of 1−1=0 at 908 and therefore transmit its MSG 3 at 908. As another example, a UE with a counter value of 2 at 906 would wait another two intervals 904 and have a counter value of 2−1−1=0 at 910 and therefore transmit its MSG 3 at 910.

In some aspects, a network entity may adjust the counter for a UE. For example, the network entity may decrease the counter by an additional unit (e.g., 1) or by another number (e.g., 2) by using a counter adjustment command. FIG. 9B depicts an example 950 in which UE 962 has a counter value of 0 an interval 954 after RAR message 952 is transmitted and thus transmits its MSG 3 at 956. However, in this example, a network entity (not depicted) transmits a counter adjustment command 958 to UE 964, which causes UE 964 to decrement its counter by 2 units instead of 1, and therefore transmit its MSG 3 at 960. In other words, UE 964 is promoted in time for its MSG 3 transmission based on the counter adjustment command 958.

In some aspects, the priority of the data a UE intends to transmit after completing a RACH procedure may be used to affect a randomly generated counter value, as described above for contention resolution.

For example, different types of data for transmission may be assigned different weight factors (e.g., w, where 0<w<1), and higher priority data may have a smaller weight factor w in order to generate a smaller counter value. In such cases, a UE may randomly chose a counter value in the range of [0, 2^{wX}−1].

As another example, the UE may generate a random counter value based on a weighted distribution that generates a higher probability of choosing 0 (or a lower counter value) when the data to be transmitted is higher priority. For example, if the probability of a UE choosing X=i is Pr (X=i)=wᵢ/T, where T=Σᵢwᵢ, then We can be positive integers.

As another example, the range of [0, 2^{X}−1] may be divided into segments, with each segmenting corresponding to different data type. For example, [0, 2^{X}−1] may be divided into two segments and UEs with higher priority data transmissions may be configured to pick a random value from the segment [0, Xₘᵢₙ] and UEs with lower priority data transmissions may be configured to pick a random value from the segment [Xₘᵢₙ+1, 2^{X}−1]. This may beneficially prevent a UE with a higher priority data transmission buffered from colliding with a UE with a lower priority data transmission buffered.

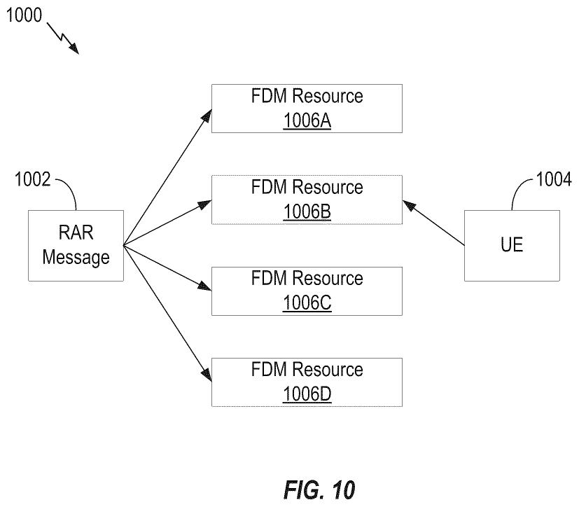

FIG. 10 depicts an example 1000 of another contention resolution concept that may be used by low-power UEs, such as ambient IoT UEs.

In particular, RAR message 1002 may define multiple FDM resources 1006A-1006D for a MSG 3 transmission by UE 1004. In some aspects, RAR message 1002 may indicate the candidate set of frequency hopping step size (e.g. (f^{RC}/xₐ . . . f^{RC}/X_{b}), where a, b=1, . . . , Nₘₐₓ−1, and Nₘₐₓ is the maximum supported division factor of the device) to UE 1004. In some aspects, UE 1004 may dynamically select one of FDM resources 1006A-1006D (e.g., FDM resource 1006B in this example). In other aspects, UE 1004 may choose one of FDM resources 1006A-1006D based on a hash of its UE ID. In yet other aspects, UE 1004 may choose one of FDM resources 1006A-1006D randomly. These are just some examples and others are possible.

### Aspects Related to Misdetection of a Rach Preamble

It is possible that a network entity may not detect (or misdetect) a preamble transmitted from a UE according to the various aspects described herein. In such cases, the UE may react in various ways.

In one aspect, the UE will randomly select a preamble and restart PRACH at the next available PRACH resource.

In another aspect, the UE will choose a new preamble which has a higher priority or the same preamble with a larger repetition to be sent at the next available PRACH resource.

In yet another aspect, the UE will use a random back-off timer and restart the PRACH after the back-off timer expires. The back-off timer may be predefined or signaled to the UE in system information (e.g., in a SIB) or in an RRC message. Alternatively, the back-off timer may be indicated in the RAR message when the network entity is aware that a collision as occurred.

### Example Operations by a User Equipment

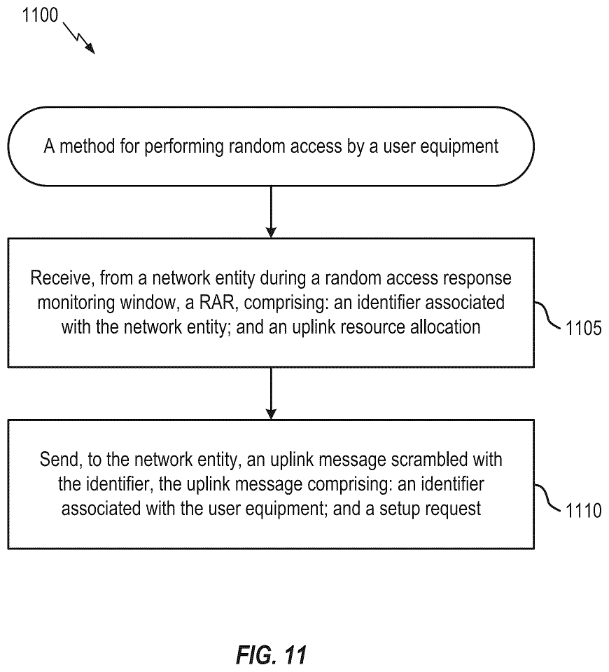

FIG. 11 shows a method 1100 for performing initial access by a user equipment, such as UE 104 of FIGS. 1 and 3.

Method 1100 begins at step 1105 with receiving, from a network entity during a random access response monitoring window, a RAR, comprising: an identifier associated with the network entity; and an uplink resource allocation. In some aspects, the uplink resource allocation may indicate one or more of TDM and/or FDM resources for the UE to use for an uplink communication.

Method 1100 then proceeds to step 1110 with sending, to the network entity, an uplink message scrambled with the identifier, the uplink message comprising: an identifier associated with the user equipment; and a setup request.

In one aspect, the RAR further comprises an indication of a received random access preamble, the identifier associated with the network entity comprises a TC-RNTI. and the RAR is received in a second message of a four-step random access procedure.

In one aspect, the indication of the received random access preamble comprises an index corresponding to the received random access preamble.

In one aspect, the indication of the received random access preamble comprises a value that is based on a starting timing and frequency of a frequency hopping pattern used by the user equipment for transmitting a random access preamble.

In one aspect, the uplink message further comprises a data payload.

In one aspect, method 1100 further includes receiving, from the network entity, a hybrid automatic repeat request acknowledging receipt of the data payload.

In one aspect, the identifier associated with the network entity comprises a C-RNTL.

In one aspect, method 1100 further includes receiving, from the network entity, a configuration for the random access response monitoring window.

In one aspect, the configuration for the random access response monitoring window is received via one of a system information message or a RRC message.

In one aspect, the random access response monitoring window is defined by at least: a starting time based on a time interval after a most recent PRACH reception; and a duration,

In one aspect, method 1100 further includes performing time synchronization with the network entity, wherein the random access response monitoring window is defined by at least: an absolute starting time; and a duration.

In one aspect, the RAR further comprises a random value seed, and the method 1100 further comprises sending, to the network entity, the uplink message after a period of time based at least in part on the random value seed.

In one aspect, method 1100 further includes generating, based on the random value seed, a number of fixed intervals before sending the uplink message,

In one aspect, method 1100 further includes receiving, from the network entity, an indication to change the number of fixed intervals before sending the uplink message.

In one aspect, method 1100 further includes changing the number of fixed intervals before sending the uplink message.

In one aspect, the method 1100 further comprises processing the random value seed with a function to generate the number of fixed intervals, the function comprises a weight value applied to the random value seed, and the weight value is based at least in part on a priority of the uplink message.

In one aspect, the RAR further comprises an indication of a candidate set of frequency resources for the uplink message, and the method 1100 further comprises: selecting a frequency resource from the candidate set of frequency resources for the uplink message; and sending, to the network entity, the uplink message on the selected frequency resource.

In one aspect, the indication of the candidate set of frequency resources for the uplink message is based on a frequency hopping step size for the user equipment. For example, the indication of the candidate set of frequency resources for the uplink message may be based on a maximum division factor for the frequency hopping step size for the user equipment.

In one aspect, selecting the frequency resource from the candidate set of frequency resources for the uplink message is based at least in part on a device identifier for the user equipment.

In one aspect, method 1100 further includes sending, to the network entity, a random access preamble on a PRACH.

In one aspect, method 1100 further includes determining that a contention resolution timer has expired.

In one aspect, method 1100 further includes restarting an initial access procedure at a next available PRACH occasion, including at least one of: randomly selecting a new random access preamble; selecting a new random access preamble with a higher priority; selecting a same random access preamble with a higher repetition; or waiting for a random back-off timer to expire prior to restarting the initial access procure, wherein the random back-off timer is either preconfigured at the user equipment or indicated by the network entity.

In one aspect, method 1100 further includes receiving, from the network entity, the identifier associated with the user equipment.

In one aspect, the user equipment comprises an ambient IoT apparatus.

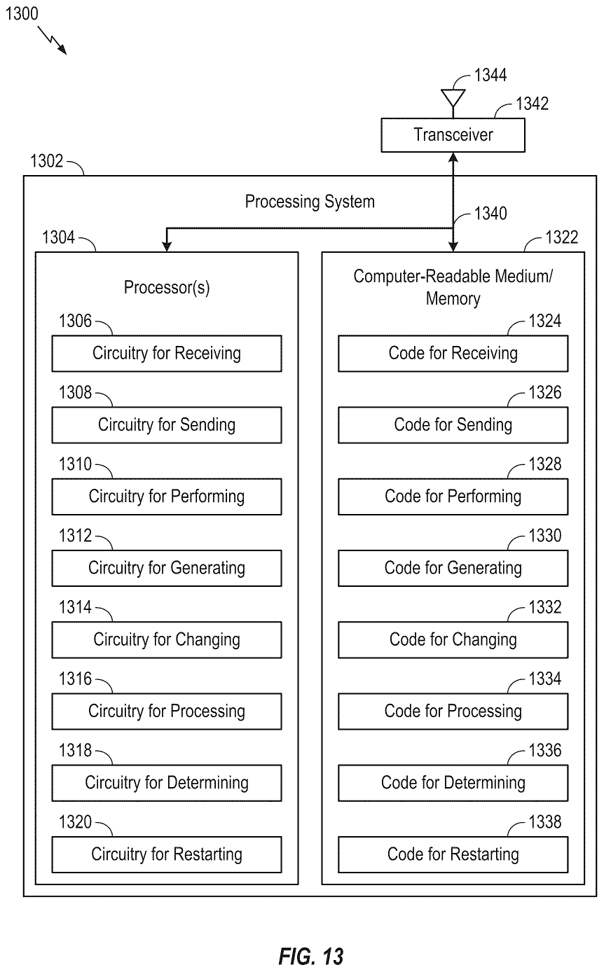

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

### Example Operations by a Network Entity

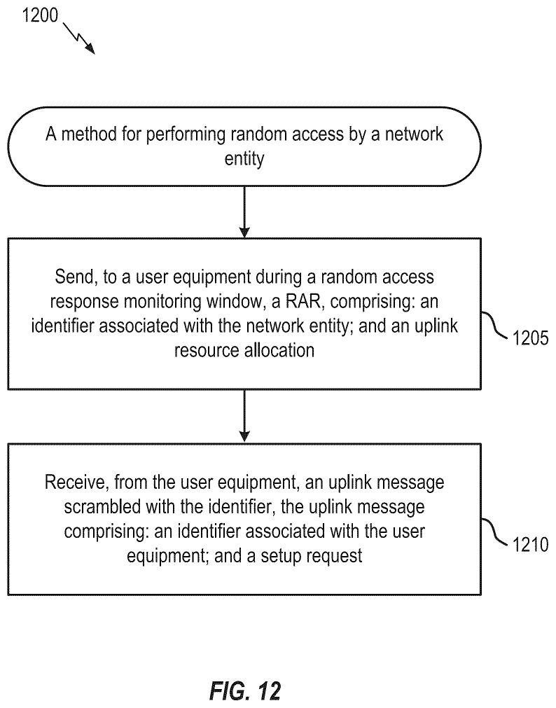

FIG. 12 shows a method 1200 for performing initial access by a network entity, such as BS 102 of FIGS. 1 and 3, or a disaggregated base station as discussed with respect to FIG. 2.

Method 1200 begins at step 1205 with sending, to a user equipment during a random access response monitoring window, a RAR, comprising: an identifier associated with the network entity; and an uplink resource allocation.

Method 1200 then proceeds to step 1210 with receiving, from the user equipment, an uplink message scrambled with the identifier, the uplink message comprising: an identifier associated with the user equipment; and a setup request.

In one aspect, the RAR further comprises an indication of a received random access preamble, the identifier associated with the network entity comprises a TC-RNTI. and the RAR is sent in a second message of a four-step random access procedure.

In one aspect, the indication of the received random access preamble comprises an index corresponding to the received random access preamble.

In one aspect, the indication of the received random access preamble comprises a value that is based on a starting timing and frequency of a frequency hopping pattern used by the user equipment for transmitting a random access preamble.

In one aspect, the uplink message further comprises a data payload.

In one aspect, method 1200 further includes sending, to the user equipment, a hybrid automatic repeat request acknowledging receipt of the data payload.

In one aspect, the identifier associated with the network entity comprises a C-RNTI.

In one aspect, method 1200 further includes sending, to the user equipment, a configuration for the random access response monitoring window.

In one aspect, the configuration for the random access response monitoring window is configured for all user equipments accessing the network entity, including the user equipment.

In one aspect, the configuration for the random access response monitoring window is configured for a subset of user equipments accessing the network entity, including the user equipment.

In one aspect, the configuration for the random access response monitoring window is sent via one of a system information message or a RRC message.

In one aspect, the random access response monitoring window is defined by at least: a starting time based on a time interval after a most recent PRACH reception; and a duration.

In one aspect, method 1200 further includes performing time synchronization with the user equipment, wherein the random access response monitoring window is defined by at least: an absolute starting time; and a duration.

In one aspect, the RAR further comprises a random value seed, and the method 1200 further comprises receiving, from the user equipment, the uplink message after a period of time based at least in part on the random value seed.

In one aspect, method 1200 further includes sending, to the user equipment, an indication to change a number of fixed intervals before sending the uplink message.

In one aspect, the RAR further comprises an indication of a candidate set of frequency resources for the uplink message, and the method 1200 further comprises receiving, from the user equipment, the uplink message on a selected frequency resource from the candidate set of frequency resources.

In one aspect, the indication of the candidate set of frequency resources for the uplink message is based on a frequency hopping step size for the user equipment.

In one aspect, method 1200 further includes receiving, from the user equipment, a random access preamble on a PRACH.

In one aspect, method 1200 further includes sending, to the user equipment, the identifier associated with the user equipment.

In one aspect, the user equipment comprises an ambient IoT apparatus.

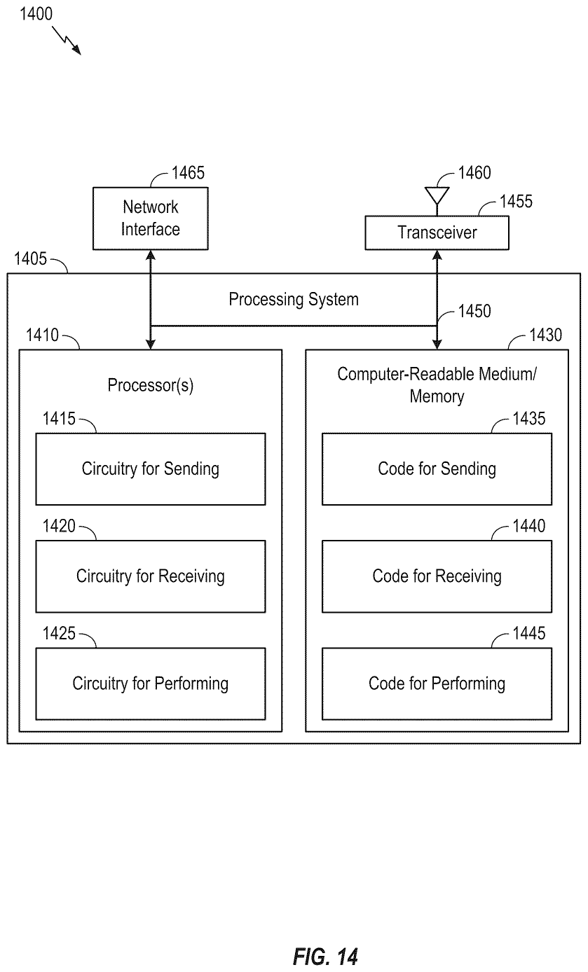

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or altemative steps are possible consistent with this disclosure.

### Example Communications Devices

FIG. 13 depicts aspects of an example communications device 1300. In some aspects, communications device 1300 is a user equipment, such as UE 104 described above with respect to FIGS. 1 and 3.

The communications device 1300 includes a processing system 1302 coupled to a transceiver 1342 (e.g., a transmitter and/or a receiver). The transceiver 1342 is configured to transmit and receive signals for the communications device 1300 via an antenna 1344, such as the various signals as described herein. The processing system 1302 may be configured to perform processing functions for the communications device 1300, including processing signals received and/or to be transmitted by the communications device 1300.

The processing system 1302 includes one or more processors 1304. In various aspects, the one or more processors 1304 may be representative of one or more of receive processor 358, transmit processor 364, TX MIMO processor 366, and/or controller/processor 380, as described with respect to FIG. 3. The one or more processors 1304 are coupled to a computer-readable medium/memory 1322 via a bus 1340. In certain aspects, the computer-readable medium/memory 1322 is configured to store instructions (e.g., computer-executable code) that when executed by the one or more processors 1304, enable and cause the one or more processors 1304 to perform the method 1100 described with respect to FIG. 11, or any aspect related to it, including any additional steps or sub-steps described in relation to FIG. 11. Note that reference to a processor performing a function of communications device 1300 may include one or more processors performing that function of communications device 1300.

In the depicted example, computer-readable medium/memory 1322 stores code for receiving 1324, code for sending 1326, code for performing 1328, code for generating 1330, code for changing 1332, code for processing 1334, code for determining 1336, and code for restarting 1338. Processing of the code 1324-1338 may enable and cause the communications device 1300 to perform the method 1100 described with respect to FIG. 11, or any aspect related to it.

The one or more processors 1304 include circuitry configured to implement (e.g., execute) the code stored in the computer-readable medium/memory 1322, including circuitry for receiving 1306, circuitry for sending 1308, circuitry for performing 1310, circuitry for generating 1312, circuitry for changing 1314, circuitry for processing 1316, circuitry for determining 1318, and circuitry for restarting 1320. Processing with circuitry 1306-1320 may enable and cause the communications device 1300 to perform the method 1100 described with respect to FIG. 11, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1342 and/or antenna 1344 of the communications device 1300 in FIG. 13, and/or one or more processors 1304 of the communications device 1300 in FIG. 13. Means for communicating, receiving or obtaining may include the transceivers 354, antenna(s) 352, receive processor 358, and/or controller/processor 380 of the UE 104 illustrated in FIG. 3, transceiver 1342 and/or antenna 1344 of the communications device 1300 in FIG. 13, and/or one or more processors 1304 of the communications device 1300 in FIG. 13.

FIG. 14 depicts aspects of an example communications device. In some aspects, communications device 1400 is a network entity, such as BS 102 of FIGS. 1 and 3, or a disaggregated base station as discussed with respect to FIG. 2.

The communications device 1400 includes a processing system 1405 coupled to a transceiver 1455 (e.g., a transmitter and/or a receiver) and/or a network interface 1465. The transceiver 1455 is configured to transmit and receive signals for the communications device 1400 via an antenna 1460, such as the various signals as described herein. The network interface 1465 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1430 via a bus 1450. In certain aspects, the computer-readable medium/memory 1430 is configured to store instructions (e.g., computer-executable code) that when executed by the one or more processors 1410, enable and cause the one or more processors 1410 to perform the method 1200 described with respect to FIG. 12, or any aspect related to it, including any additional steps or sub-steps described in relation to FIG. 12. Note that reference to a processor of communications device 1400 performing a function may include one or more processors of communications device 1400 performing that function.

In the depicted example, the computer-readable medium/memory 1430 stores code for sending 1435, code for receiving 1440, and code for performing 1445. Processing of the code 1435-1445 may enable and cause the communications device 1400 to perform the method 1200 described with respect to FIG. 12, or any aspect related to it.

The one or more processors 1410 include circuitry configured to implement (e.g., execute) the code stored in the computer-readable medium/memory 1430, including circuitry for sending 1415, circuitry for receiving 1420, and circuitry for performing 1425. Processing with circuitry 1415-1425 may enable and cause the communications device 1400 to perform the method 1200 described with respect to FIG. 12, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1455 and/or antenna 1460 of the communications device 1400 in FIG. 14, and/or one or more processors 1410 of the communications device 1400 in FIG. 14. Means for communicating, receiving or obtaining may include the transceivers 332, antenna(s) 334, receive processor 338, and/or controller/processor 340 of the BS 102 illustrated in FIG. 3, transceiver 1455 and/or antenna 1460 of the communications device 1400 in FIG. 14, and/or one or more processors 1410 of the communications devie 1400 in FIG. 14.

### Example Clauses

Implementation examples are described in the following numbered clauses:
Clause 1: A method for performing initial access by a user equipment, comprising: receiving, from a network entity during a random access response monitoring window, a RAR, comprising: an identifier associated with the network entity; and an uplink resource allocation; and sending, to the network entity, an uplink message scrambled with the identifier, the uplink message comprising: an identifier associated with the user equipment; and a setup request.
Clause 2: The method of Clause 1, wherein: the RAR further comprises an indication of a received random access preamble, the identifier associated with the network entity comprises a TC-RNTI, and the RAR is received in a second message of a four-step random access procedure.
Clause 3: The method of Clause 2, wherein the indication of the received random access preamble comprises an index corresponding to the received random access preamble.
Clause 4: The method of Clause 2, wherein the indication of the received random access preamble comprises a value that is based on a starting timing and frequency of a frequency hopping pattern used by the user equipment for transmitting a random access preamble.
Clause 5: The method of any one of Clauses 1-4, wherein the uplink message further comprises a data payload.
Clause 6: The method of Clause 5, further comprising receiving, from the network entity, a hybrid automatic repeat request acknowledging receipt of the data payload.
Clause 7: The method of any one of Clauses 1-6, wherein the identifier associated with the network entity comprises a C-RNTL.
Clause 8: The method of any one of Clauses 1-7, further comprising receiving, from the network entity, a configuration for the random access response monitoring window.
Clause 9: The method of Clause 8, wherein the configuration for the random access response monitoring window is received via one of a system information message or a RRC message.
Clause 10: The method of any one of Clauses 1-9, wherein the random access response monitoring window is defined by at least: a starting time based on a time interval after a most recent PRACH reception; and a duration.
Clause 11: The method of any one of Clauses 1-10, further comprising: performing time synchronization with the network entity, wherein the random access response monitoring window is defined by at least: an absolute starting time; and a duration.
Clause 12: The method of any one of Clauses 1-11, wherein: the RAR further comprises a random value seed, and the method further comprises sending, to the network entity, the uplink message after a period of time based at least in part on the random value seed.
Clause 13: The method of Clause 12, further comprising generating, based on the random value seed, a number of fixed intervals before sending the uplink message.
Clause 14: The method of Clause 13, further comprising: receiving, from the network entity, an indication to change the number of fixed intervals before sending the uplink message; and changing the number of fixed intervals before sending the uplink message.
Clause 15: The method of Clause 13, wherein: the method further comprises processing the random value seed with a function to generate the number of fixed intervals, the function comprises a weight value applied to the random value seed, and the weight value is based at least in part on a priority of the uplink message.
Clause 16: The method of any one of Clauses 1-15, wherein: the RAR further comprises an indication of a candidate set of frequency resources for the uplink message, and the method further comprises: selecting a frequency resource from the candidate set of frequency resources for the uplink message; and sending, to the network entity, the uplink message on the selected frequency resource.
Clause 17: The method of Clause 16, wherein the indication of the candidate set of frequency resources for the uplink message is based on a frequency hopping step size for the user equipment.
Clause 18: The method of Clause 16, wherein selecting the frequency resource from the candidate set of frequency resources for the uplink message is based at least in part on a device identifier for the user equipment.
Clause 19: The method of any one of Clauses 1-18, further comprising sending, to the network entity, a random access preamble on a PRACH.
Clause 20: The method of Clause 19, further comprising: determining that a contention resolution timer has expired; and restarting an initial access procedure at a next available PRACH occasion, including at least one of: randomly selecting a new random access preamble; selecting a new random access preamble with a higher priority; selecting a same random access preamble with a higher repetition; or waiting for a random back-off timer to expire prior to restarting the initial access procure, wherein the random back-off timer is either preconfigured at the user equipment or indicated by the network entity.
Clause 21: The method of any one of Clauses 1-20, further comprising receiving, from the network entity, the identifier associated with the user equipment.
Clause 22: The method of any one of Clauses 1-21, wherein the user equipment comprises an ambient IoT apparatus.
Clause 23: A method for performing initial access by a network entity, comprising: sending, to a user equipment during a random access response monitoring window, a RAR, comprising: an identifier associated with the network entity; and an uplink resource allocation; and receiving, from the user equipment, an uplink message scrambled with the identifier, the uplink message comprising: an identifier associated with the user equipment; and a setup request.
Clause 24: The method of Clause 23, wherein: the RAR further comprises an indication of a received random access preamble, the identifier associated with the network entity comprises a TC-RNTI, and the RAR is sent in a second message of a four-step random access procedure.
Clause 25; The method of Clause 24, wherein the indication of the received random access preamble comprises an index corresponding to the received random access preamble.
Clause 26: The method of Clause 24, wherein the indication of the received random access preamble comprises a value that is based on a starting timing and frequency of a frequency hopping pattern used by the user equipment for transmitting a random access preamble.
Clause 27: The method of any one of Clauses 23-26, wherein the uplink message further comprises a data payload.
Clause 28: The method of Clause 27, further comprising sending, to the user equipment, a hybrid automatic repeat request acknowledging receipt of the data payload.
Clause 29: The method of any one of Clauses 23-28, wherein the identifier associated with the network entity comprises a C-RNTI.
Clause 30: The method of any one of Clauses 23-29, further comprising sending, to the user equipment, a configuration for the random access response monitoring window.
Clause 31: The method of Clause 30, wherein the configuration for the random access response monitoring window is configured for all user equipments accessing the network entity, including the user equipment.
Clause 32: The method of Clause 30, wherein the configuration for the random access response monitoring window is configured for a subset of user equipments accessing the network entity, including the user equipment.
Clause 33: The method of Clause 30, wherein the configuration for the random access response monitoring window is sent via one of a system information message or a RRC message.
Clause 34; The method of any one of Clauses 23-33, wherein the random access response monitoring window is defined by at least: a starting time based on a time interval after a most recent PRACH reception; and a duration.
Clause 35: The method of any one of Clauses 23-34, further comprising: performing time synchronization with the user equipment, wherein the random access response monitoring window is defined by at least: an absolute starting time; and a duration.
Clause 36: The method of any one of Clauses 23-35, wherein: the RAR further comprises a random value seed, and the method further comprises receiving, from the user equipment, the uplink message after a period of time based at least in part on the random value seed.
Clause 37: The method of any one of Clauses 23-36, further comprising sending, to the user equipment, an indication to change a number of fixed intervals before sending the uplink message.
Clause 38: The method of any one of Clauses 23-37, wherein: the RAR further comprises an indication of a candidate set of frequency resources for the uplink message, and the method further comprises receiving, from the user equipment, the uplink message on a selected frequency resource from the candidate set of frequency resources.
Clause 39: The method of Clause 38, wherein the indication of the candidate set of frequency resources for the uplink message is based on a frequency hopping step size for the user equipment.
Clause 40: The method of any one of Clauses 23-39, further comprising receiving, from the user equipment, a random access preamble on a PRACH.
Clause 41: The method of any one of Clauses 23-40, further comprising sending, to the user equipment, the identifier associated with the user equipment.
Clause 42: The method of any one of Clauses 23-41, wherein the user equipment comprises an ambient IoT apparatus.
Clause 43: An apparatus, comprising: a memory comprising executable instructions; and a processor configured to execute the executable instructions and cause the apparatus to perform a method in accordance with any one of Clauses 1-42.
Clause 44: An apparatus, comprising means for performing a method in accordance with any one of Clauses 1-42.
Clause 45: A non-transitory computer-readable medium comprising executable instructions that, when executed by a processor of an apparatus, cause the apparatus to perform a method in accordance with any one of Clauses 1-42.
Clause 46: A computer program product embodied on a computer-readable storage medium comprising code for performing a method in accordance with any one of Clauses 1-42.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the altemative, the processor may be any commercially available processor, controller. microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c. b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment configured for performing random access, comprising:
a memory comprising processor-executable instructions; and a processor configured to execute the processor-executable instructions and cause the user equipment to:
receive, from a network entity during a random access response monitoring window, a random access response (RAR), comprising:
an identifier associated with the network entity; and
an uplink resource allocation; and
send, to the network entity, an uplink message scrambled with the identifier, the uplink message comprising:
an identifier associated with the user equipment; and
a setup request,
wherein the user equipment comprises an ambient internet of things (IoT) user equipment.

2. The user equipment of claim 1, wherein the RAR comprises at least one of:
an index corresponding to a received random access preamble; or a value that is based on a starting timing and frequency of a frequency hopping pattern used by the user equipment for transmitting a random access preamble.

3. The user equipment of claim 1, wherein:
the uplink message further comprises a data payload, and
the processor is configured to execute the processor-executable instructions and further cause the user equipment to receive, from the network entity, a hybrid automatic repeat request acknowledging receipt of the data payload.

4. The user equipment of claim 1, wherein:
the processor is configured to execute the processor-executable instructions and further cause the user equipment to receive, from the network entity, a configuration for the random access response monitoring window, and
the configuration for the random access response monitoring window includes at least:
a starting time based on a time interval after a most recent physical random access channel (PRACH) reception; and
a duration.

5. The user equipment of claim 1, wherein: the processor is configured to execute the processor-executable instructions and further cause the user equipment to:
the processor is configured to execute the processor-executable instructions and further cause the user equipment to:
receive, from the network entity, a configuration for the random access response monitoring window; and
perform time synchronization with the network entity, the configuration for random access response monitoring window includes at least:
an absolute starting time; and
a duration.

6. The user equipment of claim 1, wherein:
the RAR further comprises a random value seed, and
the processor is configured to execute the processor-executable instructions and further cause the user equipment to send, to the network entity, the uplink message after a period of time based at least in part on the random value seed.

7. The user equipment of claim 6, wherein the processor is configured to execute the processor-executable instructions and further cause the user equipment to generate, based on the random value seed, a number of fixed intervals before sending the uplink message.

8. The user equipment of claim 7, wherein the processor is configured to execute the processor-executable instructions and further cause the user equipment to:
receive, from the network entity, an indication to change the number of fixed intervals before sending the uplink message; and
change the number of fixed intervals before sending the uplink message.

9. The user equipment of claim 7, wherein:
the processor is configured to execute the processor-executable instructions and further cause the user equipment to process the random value seed with a function to generate the number of fixed intervals,
the function comprises a weight value applied to the random value seed, and
the weight value is based at least in part on a priority of the uplink message.

10. The user equipment of claim 1, wherein:
the RAR further comprises an indication of a candidate set of frequency resources for the uplink message, and
the processor is configured to execute the processor-executable instructions and further cause the user equipment to:
select a frequency resource from the candidate set of frequency resources for the uplink message; and
send, to the network entity, the uplink message on the selected frequency resource.

11. The user equipment of claim 10, wherein the indication of the candidate set of frequency resources for the uplink message is based on a frequency hopping step size for the user equipment.

12. The user equipment of claim 10, wherein selecting the frequency resource from the candidate set of frequency resources for the uplink message is based at least in part on a device identifier for the user equipment.

13. The user equipment of claim 1, wherein the processor is configured to execute the processor-executable instructions and further cause the user equipment to send, to the network entity, a random access preamble on a physical random access channel (PRACH).

14. The user equipment of claim 13, wherein the processor is configured to execute the processor-executable instructions and further cause the user equipment to:
determine that a contention resolution timer has expired;
restart an initial access procedure at a next available PRACH occasion, including at least one of:
randomly selecting a new random access preamble;
selecting a new random access preamble with a higher priority;
selecting a same random access preamble with a higher repetition; or
waiting for a random back-off timer to expire prior to restarting the initial access procure, wherein the random back-off timer is either preconfigured at the user equipment or indicated by the network entity.

15. A method for performing initial access by a user equipment, comprising:
receiving, from a network entity during a random access response monitoring window, a random access response (RAR), comprising:
an identifier associated with the network entity; and
an uplink resource allocation; and
sending, to the network entity, an uplink message scrambled with the identifier, the uplink message comprising:
an identifier associated with the user equipment; and
a setup request,
wherein the user equipment is an ambient internet of things (IoT) user equipment.

16. A network entity configured for performing random access, comprising: a
memory comprising processor-executable instructions; and a processor configured to execute the processor-executable instructions and cause the network entity to:
send, to a user equipment during a random access response monitoring window, a random access response (RAR), comprising:
an identifier associated with the network entity; and
an uplink resource allocation; and
receive, from the user equipment, an uplink message scrambled with the identifier, the uplink message comprising:
an identifier associated with the user equipment; and
a setup request, wherein the user equipment is an ambient internet of things (IOT) user equipment.

17. The network entity of claim 16, wherein the RAR comprises at least one of:
an index corresponding to a received random access preamble; or a value that is based on a starting timing and frequency of a frequency hopping pattern used by the user equipment for transmitting a random access preamble.

18. The network entity of claim 16, wherein:
the uplink message further comprises a data payload, and
the processor is configured to execute the processor-executable instructions and further cause the network entity to send, to the user equipment, a hybrid automatic repeat request acknowledging receipt of the data payload.

19. The network entity of claim 16, wherein:
the processor is configured to execute the processor-executable instructions and further cause the network entity to send, to the user equipment, a configuration for the random access response monitoring window, and
the configuration for the random access response monitoring window is includes at least:
a starting time based on a time interval after a most recent physical random access channel (PRACH) reception; and
a duration.

20. The network entity of claim 19, wherein the configuration for the random access response monitoring window is configured for all user equipments accessing the network entity, including the user equipment, or for a subset of user equipments accessing the network entity, including the user equipment.

21-30. (canceled)
